(19) United States
(12) Patent Application Publication
(10) Pub. No.: US 2026/0368546 A1
(43) Pub. Date: Nov. 19, 2026

(54) MODEL LEARNING SYSTEM, METHOD, APPARATUS AND PROGRAMS

(71) Applicant: NTT, Inc., Tokyo (JP)

(72) Inventors: Iifan TYOU, Musashino-shi, Tokyo (JP); Kenta NIWA, Musashino-shi, Tokyo (JP); Takumi FUKAMI, Musashino-shi, Tokyo (JP)

(73) Assignee: NTT, Inc., Tokyo (JP)

(21) Appl. No.: 19/142,972

(22) PCT Filed: Jan. 23, 2023
(86) PCT No.: PCT/JP2023/001869

§ 371 Date: Jun. 25, 2025

(51) Int. Cl. G06N 3/098

(52) U.S. Cl. CPC G06N 3/098

(57) ABSTRACT

A model learning system includes a plurality of model learning devices. A server device includes a first transmission unit, a reception unit, a calculation unit, a second transmission unit, and a control unit. A model learning device i includes a first reception unit i1, a model parameter calculation unit i2, a transmission unit i3, a second reception unit i4, a control variable calculation unit i5, and a control unit i6. Learning of parameters of a model is performed K times in a local round, and then the parameters of the model are transmitted and received, thereby reducing the number of communications. Therefore, learning efficiency for communication is improved than before.

### TECHNICAL FIELD

The disclosed technique relates to federated learning.

### BACKGROUND ART

According to federated learning, it is possible to create a model that learns characteristics of all data while protecting data of participants who participate in federated learning by sharing only a model (learning gradient) without sharing the data. As a federated learning method, for example, a method called model averaging FedAvg is known.

However, it is known that, in a case where each participant performs learning on dissimilar data, learning does not proceed in the method called model averaging FedAvg, and learning accuracy is not improved.

Therefore, a method called SCAFFOLD has been proposed as a method of performing federated learning with high accuracy even for bias in data by controlling variance of a main variable (=a model to be learned) by using a control value (see, for example, Non Patent Literature 1).

### CITATION LIST

### Non Patent Literature

Non Patent Literature 1: Karimireddy, S.P., Kale, S., Mohri, M., Reddi, S., Stich, S., Suresh, A. T., “SCAFFOLD: Stochastic Controlled Averaging for Federated Learning. Proceedings of the 37th International Conference on Machine Learning”, in Proceedings of Machine Learning Research 119:5132-5143, 2020

### SUMMARY OF INVENTION

### Technical Problem

However, in SCAFFOLD, convergence of learning is good, but an amount of communication is about twice the amount of communication of the model averaging FedAvg.

Thus, there is a problem that learning efficiency for communication is poor.

An object of the disclosed technique is to provide a model learning system, method, device, and program having higher learning efficiency for communication than before.

### Solution to Problem

An aspect of a disclosed technique is a model learning system including a server device and a plurality of model learning devices, in which, when i and j are indexes indicating any of the plurality of model learning devices, i=1, . . . , N and j=1, N are satisfied, N is a predetermined positive integer, r is the number of rounds, r=0, . . . , R−1 is satisfied, R is a predetermined positive integer, xᵢ^{(r)} is a parameter of a model learned by the model learning device i in the round r, xᵢ⁽⁰⁾ is an initial value of a parameter of a model to be learned by the model learning device i, and ~x⁽⁰⁾ is a predetermined initial value, the server device includes a first transmission unit that transmits ~x⁽⁰⁾ to each model learning device i, a reception unit that receives xⱼ^{(r+1)} from each model learning device j, a calculation unit that calculates ~x^{(r+1)}=(1/n)Σⱼ₌₁^{N}xⱼ^{(r+1)}, a second transmission unit that transmits ~x^{(r+1)} to each model learning device i, and a control unit that performs control such that processing of the reception unit, the calculation unit, and the second transmission unit is performed for each of r=0, . . . , R−1, and the model learning device i includes a first reception unit that receives ~x⁽⁰⁾ from the server device, a model parameter calculation unit that performs processing of calculating vᵢ^{(r),k+1}, =∇Fᵢ(xᵢ^{(r),k})−λᵢ^{(r)} and xᵢ^{(r),k+1}=~xᵢ^{(r),k}−ηvᵢ^{(r),k+1} for each of k=0, . . . , K−1 to calculate xᵢ^{(r),K}, where xᵢ⁽⁰⁾ is ~x⁽⁰⁾, xᵢ^{(r),0} is xᵢ^{(r)}, ~xᵢ^{(r),0} is ~xᵢ^{(r)}, ~xᵢ^{(r),k} is xᵢ^{(r),k}, ∇Fᵢ(xᵢ^{(r),k}) is a probability gradient when learning data is applied to a model determined by xᵢ^{(r),k}, λᵢ^{(r)} is a control variable for correcting bias in data of the model learning device i in the round r, λᵢ⁽⁰⁾ is a predetermined initial value, η is a learning rate and has a predetermined value larger than 0, k is the number of local rounds, and K is a predetermined positive integer, a transmission unit that transmits xᵢ^{(r+1)} to the server device, where xᵢ^{(r+1)} is xᵢ^{(r),k}, a second reception unit that receives ~x^{(r+1)} from the server device, a control variable calculation unit that calculates λᵢ^{(r+1)}=λᵢ^{(r)}−(1/Kη) (~x^{(r+1)}−xᵢ^{(r+1)}), and a control unit that performs control such that processing of the first reception unit, the model parameter calculation unit, the transmission unit, the second reception unit, and the control variable calculation unit is performed for each of r=0, . . . , R−1.

### Advantageous Effects of Invention

According to the disclosed technique, it is possible to perform model learning having higher learning efficiency for communication than before.

### BRIEF DESCRIPTION OF DRAWINGS

FIG. 1 shows an example of a functional configuration of a model learning system.

FIG. 2 shows an example of a functional configuration of a server device.

FIG. 3 shows an example of a processing procedure of a server device.

FIG. 4 shows an example of a functional configuration of a model learning device.

FIG. 5 shows an example of a processing procedure of a model learning device.

FIG. 6 shows an example of processing to be executed by a model learning system and method.

FIG. 7 shows a functional configuration example of a computer.

### DESCRIPTION OF EMBODIMENTS

Hereinafter, embodiments of the disclosed technique will be described with reference to the drawings. Note that, in the drawings, components having the same functions are denoted by the same reference numerals, and redundant description will be omitted.

The symbol “~” used in the text should originally be written immediately above the immediately following character, but is written immediately before the character due to limitations of text notation. In mathematical expressions, the symbol is written at its original position, that is, directly above the character. For example, “~X” in the text is written as follows in a mathematical expression.

\tilde{X} [Math. 1]

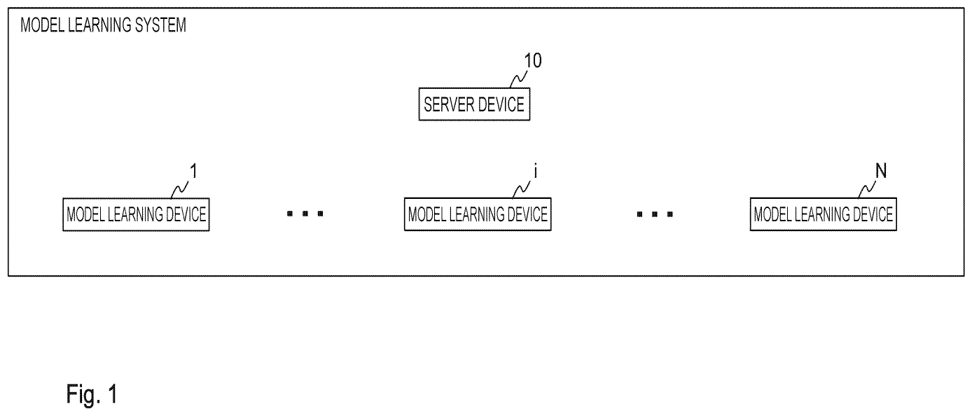

As shown in FIG. 1, a model learning system includes a server device 10 and a plurality of model learning devices 1, . . . , and N. The plurality of model learning devices 1, . . . , and N is N model learning devices. N is a predetermined positive integer. An index indicating any of the plurality of model learning devices is defined as i. Regarding i, i=1, . . . , N is satisfied.

The plurality of model learning devices 1, . . . , and N is connected to the server device 10 so as to be able to transmit and receive information.

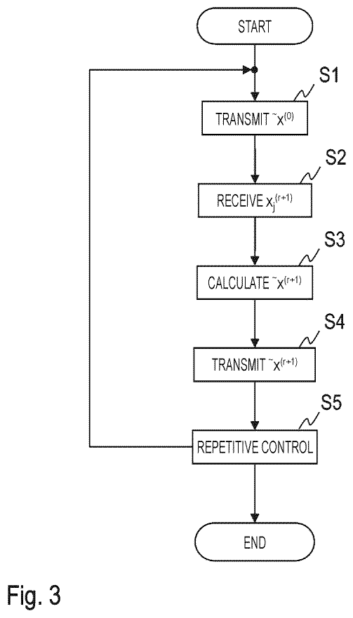

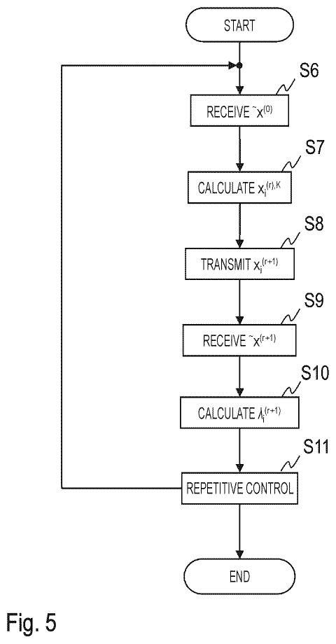

A model learning method is implemented, for example, by each component of the model learning system performing processing in steps S1 to S11 in FIGS. 3 and 5.

Specifically, the model learning method is implemented, for example, by each component of the server device 10 performing processing in steps S1 to S5 in FIG. 3 and each component of the model learning device i performing processing in steps S6 to S11 in FIG. 5.

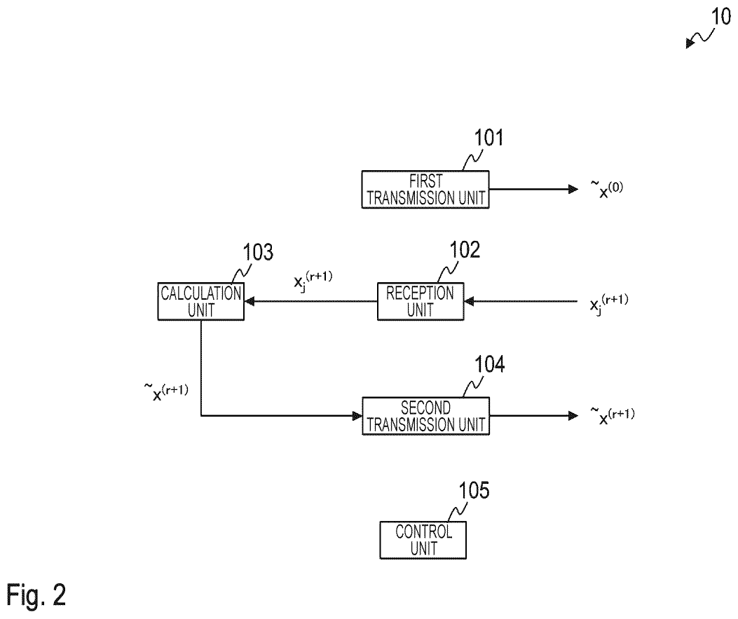

As shown in FIG. 2, the server device 10 includes a first transmission unit 101, a reception unit 102, a calculation unit 103, a second transmission unit 104, and a control unit 105.

The first transmission unit 101 transmits ~x⁽⁰⁾ to each model learning device i (step S1). Here, ~x⁽⁰⁾ is a predetermined initial value. For example, ~x⁽⁰⁾ is randomly determined. This ~x⁽⁰⁾ is a vector having the same number of dimensions as the number of dimensions D of a neural network that is a model to be learned.

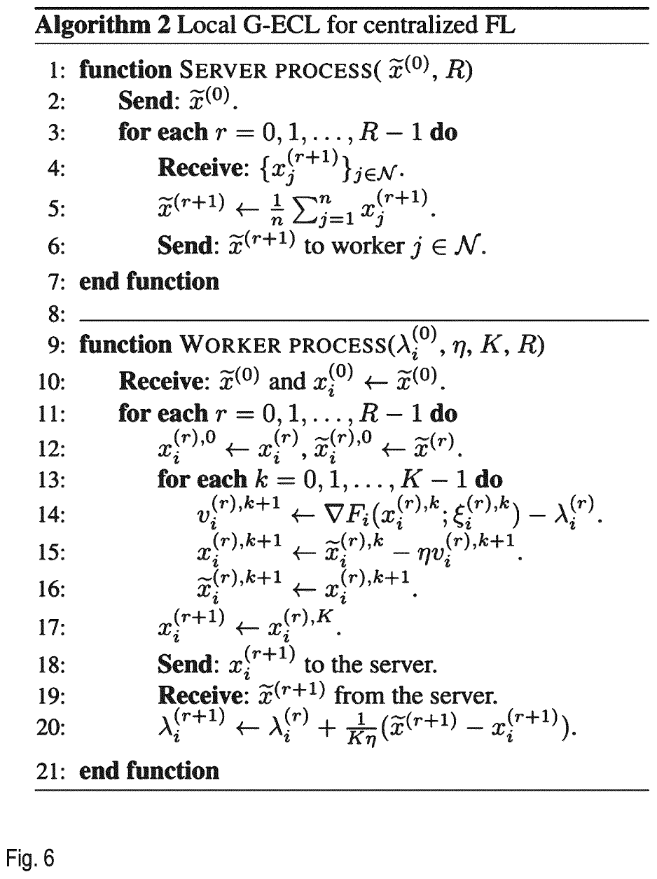

The processing in step S1 corresponds to “2:” in FIG. 6. FIG. 6 shows an example of processing to be executed by the model learning system and method. In FIG. 6, ∇Fᵢ(xᵢ^{(r),k}; ξᵢ^{(r),k}) means ∇Fᵢ(xᵢ^{(r),k}).

When r is the number of rounds, r=0, . . . , R−1 is satisfied, and R is a predetermined positive integer, the server device 10 performs the following processing from steps S2 to S4 for each round r. Repetitive processing from steps S2 to S4 is performed under the control of the control unit 105 described later.

Note that r on the right shoulder of each character (e.g. xᵢ^{(r)}) is written to be conscious of processing for each round, but in terms of implementation, memory consumption can be reduced by using the same variable.

The character xᵢ^{(r)} is a parameter of a model learned by the model learning device i in the round r, and xᵢ⁽⁰⁾ is an initial value of a parameter of a model to be learned by the model learning device i. Those xᵢ^{(r)} and xᵢ⁽⁰⁾ are vectors having the same number of dimensions as the number of dimensions D of a neural network that is a model to be learned.

The reception unit 102 receives xⱼ^{(r+1)} each model learning device j (step S2). The received xⱼ^{(r+1)} is output to the calculation unit 103. As described later, xⱼ^{(r+1)} is calculated by the model learning device j in processing in step S7.

The processing in step S2 corresponds to “4:” and “5:” in FIG. 6.

The calculation unit 103 calculates ~x^{(r+1)}=(1/n)Σⱼ₌₁^{N}xⱼ^{(r+1)} (step S3). The calculated ~x^{(r+1)} is output to the second transmission unit 104.

Note that the tilde (~) on the left shoulder of each character (e.g. ~xᵢ^{(r+10)}) intends a parameter of a global model, in other words, an average value of model parameters exchanged with another machine.

The processing in step S3 corresponds to “6:” in FIG. 6.

The second transmission unit 104 transmits ~x^{(r+1)} to each model learning device i (step S4).

The processing in step S4 corresponds to “7:” in FIG. 6.

The control unit 105 performs control such that the processing of the reception unit 102, the calculation unit 103, and the second transmission unit 104 is performed for each of r=0, . . . , R−1 (step S5).

The processing in step S5 corresponds to “3:” in FIG. 6.

Next, a configuration of the model learning device i will be described with i=1, . . . , N.

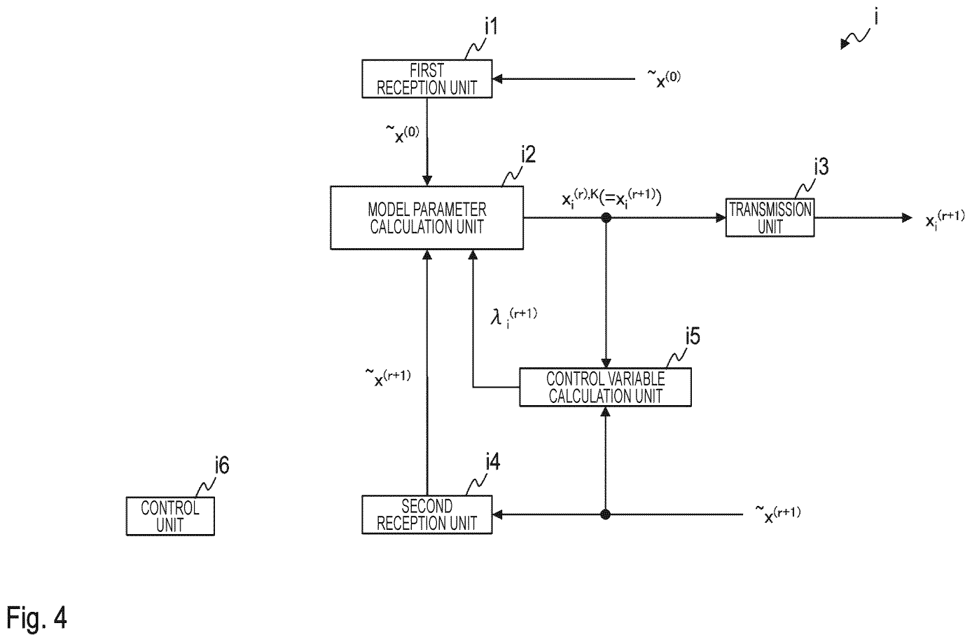

As shown in FIG. 4, the model learning device i includes, for example, a first reception unit i1, a model parameter calculation unit i2, a transmission unit i3, a second reception unit i4, a control variable calculation unit i5, and a control unit i6.

When r is the number of rounds, r=0, . . . , R−1 is satisfied, and R is a predetermined positive integer, the model learning device i performs the following processing from steps S6 to S10 for each round r. Repetitive processing from steps S6 to S10 is performed under the control of the control unit i6 described later. Each model learning device i performs the processing from steps S6 to S11.

The first reception unit i1 receives ~x⁽⁰⁾ from the server device 10 (step S6). The received ~x⁽⁰⁾ is output to the model parameter calculation unit i2.

The processing in step S6 corresponds to “11:” in FIG. 6.

The model parameter calculation unit i2 performs processing of calculating vᵢ^{(r),k+1}=∇Fᵢ(xᵢ^{(r),k})−λᵢ^{(r)} and xᵢ^{(r),k+1}=~xᵢ^{(r),k}−ηvᵢ^{(r),k+1} for each of k=0, . . . , K−1 to calculate xᵢ^{(r),k} (step S7). The calculated xᵢ^{(r),K} is output to the transmission unit i3 and the control variable calculation unit i5.

The processing in step S7 corresponds to “14:” to “17:” in FIG. 6.

Here, xᵢ⁽⁰⁾ is ~x⁽⁰⁾, xᵢ^{(r),0} is xᵢ^{(r)}, ~xᵢ^{(r),0} is ~xᵢ^{(r)}, ~xᵢ^{(r),k} is xᵢ^{(r),k}, ∇Fᵢ(xᵢ^{(r),k}) is a probability gradient when learning data is applied to a model determined by xᵢ^{(r),k}, λᵢ^{(r)} is a control variable for correcting bias in data of the model learning device i in the round r, λᵢ⁽⁰⁾ is a predetermined initial value, η is a learning rate and has a predetermined value larger than 0, k is the number of local rounds, and K is a predetermined positive integer.

The transmission unit i3 transmits xᵢ^{(r+1)} to the server device 10, where xᵢ^{(r+1)} is xᵢ^{(r),k} (step S8).

The processing in step S8 corresponds to “18:” and “19:” in FIG. 6.

The second reception unit 14 receives ~x^{(r+1)} from the server device 10 (step S9). The received ~x^{(r+1)} is output to the model parameter calculation unit i2 and the control variable calculation unit i5.

The processing in step S9 corresponds to “20:” in FIG. 6.

The control variable calculation unit i5 calculates λᵢ^{(r+1)}=λᵢ^{(r)}−(1/Kη) (~x^{(r+1)}−xᵢ^{(r+1)}) (step S10). The calculated λᵢ^{(r+1)} is output to the model parameter calculation unit i2.

The processing in step S10 corresponds to “21:” in FIG. 6.

The control unit 16 performs control such that the processing of the first reception unit i1, the model parameter calculation unit i2, the transmission unit i3, the second reception unit i4, the control variable calculation unit i5, and the control unit i6 is performed for each of r=0, . . . , R−1 (step S11).

The processing in step S11 corresponds to “12:” in FIG. 6.

Because the calculation is performed by using the control variable λ in step S7, learning can be performed even on biased data without depending only on the local information ∇Fᵢ(xᵢ^{(r),k}). Further, learning can be efficiently performed without over-learning.

Learning of the parameters of the model is performed K times in a local round in step S7, and then the parameters of the model are transmitted and received in steps S8 and S2, thereby reducing the number of communications. Therefore, the learning efficiency for communication is improved than before.

As in step S10, the model learning device i calculates the control variable λᵢ^{(r)} only on the basis of information that the model learning device i itself has, which eliminates the necessity of communication for calculating the control variable λᵢ^{(r)}. In this respect, the learning efficiency for communication is improved than before.

When fᵢ=∇Fᵢ(xᵢ⁽⁰⁾) is satisfied, the control variable λᵢ⁽⁰⁾ may be λᵢ⁽⁰⁾=fᵢ=(1/n)Σ_{i∈N}fᵢ. This processing is performed, for example, before the processing in step S1.

For example, each model learning device i calculates fᵢ=∇Fᵢ(xᵢ⁽⁰⁾) and transmits fᵢ to another model learning device. When fᵢ cannot be directly transmitted to another model learning device j, fᵢ may be transmitted to the another model learning device j via the server device 10.

Thereafter, each model learning device i calculates λᵢ⁽⁰⁾=fᵢ−(1/n)Σ_{i∈N}fᵢ by using fᵢ calculated by the model learning device itself and another model learning device.

It can also be said that the control variable λᵢ⁽⁰⁾ is “a difference between a full gradient of another model learning device to be connected and a full gradient of the model learning device i”.

When the control variable λᵢ⁽⁰⁾ is defined from the probability gradient based on xᵢ⁽⁰⁾, the control variable λᵢ⁽⁰⁾ can have a more appropriate initial value, thereby further improving the learning efficiency.

Note that ∇Fᵢ(xᵢ^{(r),k}) is defined as a probability gradient when learning data is applied to a model determined by xᵢ^{(r),k}, but ∇Fᵢ(xᵢ⁽⁰⁾) may be a so-called full gradient. Note that the full gradient cannot be practically calculated because the calculation cannot be performed in a GPU memory. Therefore, here, in order to approximate the full gradient, Fᵢ(xᵢ⁽⁰⁾) may be obtained by dividing the sum of mini-batch gradients for all data held by the model learning device i by the number of mini-batches.

### MODIFICATION

The specific configuration of the embodiment of the disclosed technique is not limited to the configuration described above. The specific configuration of the embodiment of the disclosed technique can be appropriately modified or altered in design without departing from the gist of the present disclosure.

The various types of processing described in the embodiments of the disclosed technique may be performed not only in chronological order in accordance with the described order, but also in parallel or individually depending on the processing capability of a device that performs the processing or as necessary.

For example, data exchange between the components of the model learning device may be performed directly or via a storage unit (not shown). Further, data exchange between the model learning devices may be performed directly or via a relay device such as an aggregation server (not shown).

### Program and Recording Medium

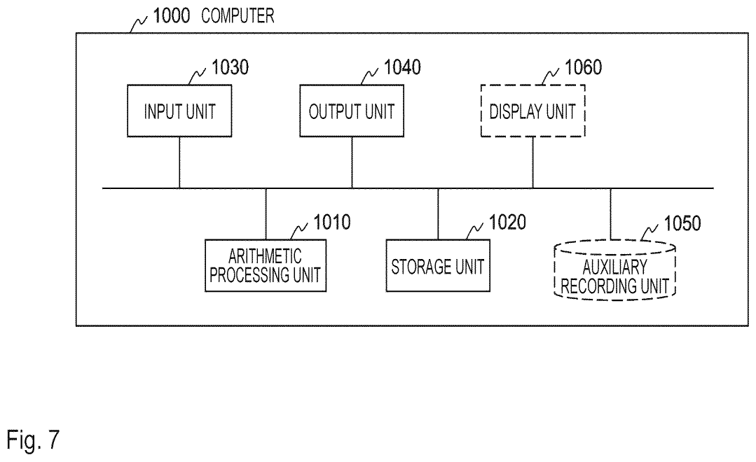

Processing of each unit of each device described above may be implemented by a computer, and in this case, processing contents of a function that each device should have are written by a program. Then, by causing a storage unit 1020 of a computer 1000 shown in FIG. 7 to read this program and causing, for example, an arithmetic processing unit 1010, an input unit 1030, an output unit 1040, and a display unit 1060 to operate, various processing functions in each device described above are achieved on the computer.

The program in which the processing contents are written can be recorded on a computer-readable recording medium. The computer-readable recording medium is, for example, a non-transitory recording medium and is specifically a magnetic recording device, an optical disc, or the like.

The program is distributed by, for example, selling, transferring, or rending a portable recording medium such as a DVD or a CD-ROM in which the program is recorded. The program may also be distributed by storing the program in a storage device of a server computer and transferring the program from the server computer to another computer via a network.

For example, a computer that executes such a program first temporarily stores the program recorded in the portable recording medium or the program transferred from the server computer in an auxiliary recording unit 1050 that is a non-transitory storage device of the computer itself. Then, at the time of performing processing, the computer reads the program stored in the auxiliary recording unit 1050 serving as the non-transitory storage device of the computer itself into the storage unit 1020 and performs processing in accordance with the read program. As another mode of executing the program, the computer may directly read the program from the portable recording medium into the storage unit 1020 and execute processing in accordance with the program, or, each time the program is transferred from the server computer to the computer, the computer may sequentially execute processing in accordance with the received program. Further, the above processing may be executed by a so-called application service provider (ASP) service that implements a processing function only by an execution instruction and result acquisition without transferring the program from the server computer to the computer. Note that the program in the present embodiment includes information used for processing by an electronic computer and equivalent to the program (data or the like that is not a direct command to the computer but has a property that defines processing of the computer).

In this mode, the present device is configured by executing a predetermined program on the computer, but at least some of the processing contents may be implemented by hardware. For example, the first transmission unit 101, the reception unit 102, the calculation unit 103, the second transmission unit 104, and the control unit 105 may be configured by a processing circuit. Further, for example, the first reception unit i1, the model parameter calculation unit i2, the transmission unit i3, the second reception unit i4, the control variable calculation unit i5, and the control unit i6 may be configured by a processing circuit.

In addition, it is needless to say that changes can be appropriately made without departing from the gist of this invention.

All documents, patent applications, and technical standards described in this specification are incorporated herein by reference to the same extent as in a case where incorporation by reference of each document, patent application, and technical standard is specifically and individually described.

1. A model learning system including a server device and a plurality of model learning devices, wherein
when i and j are indexes indicating any of the plurality of model learning devices, i=1, . . . , N and j=1, . . . , N are satisfied, N is a predetermined positive integer, r is the number of rounds, r=0, . . . , R−1 is satisfied, R is a predetermined positive integer, xᵢ^{(r)} is a parameter of a model learned by the model learning device i in the round r, xᵢ⁽⁰⁾ is an initial value of a parameter of a model to be learned by the model learning device i, and ~x⁽⁰⁾ is a predetermined initial value,
the server device includes processing circuitry configured to
transmit ~x⁽⁰⁾ to each model learning device i,
receive xⱼ^{(r+1)} from each model learning device j,
calculate ~x^{(r+1)}=(1/n)Σⱼ₌₁^{N}xⱼ^{(r+1)},
transmit ~x^{(r+1)} to each model learning device i, and
perform control such that processing of the processing circuitry is performed for each of r=0, . . . , R−1, and
the model learning device i includes processing circuitry configured to
a receive ~x⁽⁰⁾ from the server device,
perform processing of calculating vᵢ^{(r),k+1}=∇Fᵢ(xᵢ^{(r),k})−λᵢ^{(r)} and xᵢ^{(r),k+1}=~xᵢ^{(r),k}−ηvᵢ^{(r),k+1} for each of k=0, . . . , K−1 to calculate xᵢ^{(r),K}, where xᵢ⁽⁰⁾ is ~x⁽⁰⁾, xᵢ^{(r),0} is xᵢ^{(r)}, ~xᵢ^{(r),0} is ~xᵢ^{(r)}, ~xᵢ^{(r),k}, ∇Fᵢ(xᵢ^{(r),k}) when learning data is applied to a model determined by xᵢ^{(r),k}, λᵢ^{(r)} is a control variable for correcting bias in data of the model learning device i in the round r, λᵢ⁽⁰⁾ is a predetermined initial value, η is a learning rate and has a predetermined value larger than 0, k is the number of local rounds, and K is a predetermined positive integer,
transmit xᵢ^{(r+1)} to the server device, where xᵢ^{(r+1)} is xᵢ^{(r),K},
receive ~x^{(r+1)} from the server device,
calculate λᵢ^{(r+1)}=λᵢ^{(r)}−(1/Kη)(~x^{(r+1)}−xᵢ^{(r+1)}), and
perform control such that processing of the processing circuitry is performed for each of r=0, . . . , R−1.

2. The model learning system according to claim 1, wherein
fᵢ=∇Fᵢ(xᵢ⁽⁰⁾) is satisfied, and the λᵢ⁽⁰⁾ is fᵢ−(1/n)Σ_{i∈N}fᵢ.

3. A model learning method including a server device and a plurality of model learning devices, wherein
when i and j are indexes indicating any of the plurality of model learning devices, i=1, . . . , N and j=1, . . . , N are satisfied, N is a predetermined positive integer, r is the number of rounds, r=0, . . . , R−1 is satisfied, R is a predetermined positive integer, xᵢ^{(r)} is a parameter of a model learned by the model learning device i in the round r, xᵢ⁽⁰⁾ is an initial value of a parameter of a model to be learned by the model learning device i, and ~x⁽⁰⁾ is a predetermined initial value, the model learning method includes
first transmitting ~x⁽⁰⁾ to each model learning device i,
receiving xⱼ^{(r+1)} from each model learning device j,
calculating ~x^{(r+1)}=(1/n)Σⱼ₌₁^{N}xⱼ^{(r+1)},
second transmitting ~x^{(r+1)} to each model learning device i,
performing control such that processing of the receiving, the calculating, and the second transmitting is performed for each of r=0, . . . , R−1,
first receiving ~x⁽⁰⁾ from the server device,
performing processing of calculating vᵢ^{(r),k+1}=∇Fᵢ(xᵢ^{(r),k})−λᵢ^{(r)} and xᵢ^{(r),k+1}=~xᵢ^{(r),k}−μvᵢ^{(r),k+1} for each of k=0, . . . , K−1 to calculate xᵢ^{(r),K}, where xᵢ⁽⁰⁾ is ~xᵢ⁽⁰⁾, xᵢ^{(r),0} is xᵢ^{(r)}, ~xᵢ^{(r),0} is ~xᵢ^{(r)}, ~xᵢ^{(r),k} is xᵢ^{(r),k}, ∇Fᵢ(xᵢ^{(r),k}) is a probability gradient when learning data is applied to a model determined by xᵢ^{(r),k}, λᵢ^{(r)} is a control variable of the model learning device i in the round r, λᵢ⁽⁰⁾ is a predetermined initial value, η is a learning rate and has a predetermined value larger than 0, k is the number of local rounds, and K is a predetermined positive integer,
transmitting xᵢ^{(r+1)} to the server device, where xᵢ^{(r+1)} is xᵢ^{(r),K},
second receiving ~x^{(r+1)} from the server device,
calculating λᵢ^{(r+1)}=λᵢ^{(r)}−(1/Kη)(~x^{(r+1)}−xᵢ^{(r+1)}), and
performing control such that processing of the first receiving, the performing, the transmitting, the second receiving, and the calculating is performed for each of r=0, . . . , R−1.

4. A model learning device of the model learning system according to claim 1.

5. One or more non-transitory computer readable media that store a program for causing one or more computers to perform the method according to claim 3.
